(19) United States
(12) Patent Application Publication
(10) Pub. No.: US 2026/0285145 A1
(43) Pub. Date: Sep. 24, 2026

(54) LIGHT COMMERCIAL VEHICLE HAVING AN ENCLOSED SPACE COMPRISING A GAS STORAGE MODULE, AND KIT FOR EQUIPPING SUCH A VEHICLE

(71) Applicant: PHINIA DELPHI LUXEMBOURG SARL, Belvaux (LU)

(72) Inventor: Guillaume MEISSONNIER, Landes le Gaulois (FR)

(21) Appl. No.: 19/479,953

(22) PCT Filed: Apr. 23, 2024
(86) PCT No.: PCT/EP2024/061061

§ 371 Date: Oct. 29, 2025

(30) Foreign Application Priority Data
Jun. 28, 2023 (FR) 2306775

(51) Int. Cl. B60K 15/063; B60K 15/03; B60K 15/07

(52) U.S. Cl. CPC B60K 15/063; B60K 15/07; B60K 2015/03315

(57) ABSTRACT

A light commercial vehicle having an enclosed space includes an elongate pressurized gas storage module for containing a gaseous fuel for the vehicle. The storage module includes a single tank that is placed vertically in the enclosed space of the vehicle along one side of the vehicle. A kit for equipping a light commercial vehicle with a gas storage module is also provided.

### TECHNICAL FIELD

The invention relates to a light commercial vehicle having an enclosed space comprising a pressurized gas storage module serving as fuel for the vehicle, in particular dihydrogen. It relates to a kit for equipping a light commercial vehicle having an enclosed space with such a pressurized gas storage module.

### PRIOR ART

The light commercial vehicles are vehicles intended to transport goods or persons, serving urban areas in particular. They are smaller dimensions than so-called heavy-duty vehicles in order to allow them to be handled more easily in narrow streets and to have lower fuel consumption. These vehicles are generally equipped with thermal engines supplied with liquid fuel.

The objectives of reducing greenhouse gas and pollutant gas emissions suggest exploring alternatives, including supply with dihydrogen obtained from renewable energy sources. A major constraint of this technique lies in the storage of dihydrogen in the vehicle. In the solution of storing in pressurized gaseous form, it is necessary to provide a large storage volume, even at high pressures of 350 bars or even 700 bars.

Document KR 100528222 B1 shows a commercial vehicle equipped with tanks in the form of a collection of cylinders disposed horizontally one above the other at the rear of a cab. A light commercial vehicle having an enclosed space frequently includes a sliding side door for access just behind the cab. With the arrangement proposed by this document a significant part of this access is blocked by the tanks. In document EP1 373 002 A1, the tank is provided in a compartment reserved for the height of the chassis and which extends longitudinally over a good part of the length of the vehicle. Such an arrangement is only applicable to a vehicle specifically designed to receive such a tank.

Document CA2287414A1 proposes to dispose a plurality of tanks on the roof of a passenger transport vehicle. This solution requires multiplying the number of tanks in order to limit their diameter and therefore the overall height. In addition, adding elements at the top of the vehicle raises the position of the center of gravity, which is not favorable to the stability and comfort of the vehicle.

There are also known solutions that seek to place the tanks under the floor of the vehicle. Given the limited available space and the bulk of various accessories, this solution leads to multiplying the number of tanks and generally requires providing a vehicle specifically designed to receive them.

In most cases, the volume of each tank is less than 150 liters, and 250 liters in very rare cases.

### DISCLOSURE OF THE INVENTION

The invention therefore aims to provide a light commercial vehicle having an enclosed space which can be easily equipped with a reserve of fuel in gaseous form and with a limited impact on the use of the enclosed space.

With these objectives in view, the invention relates to a light commercial vehicle having an enclosed space intended to house persons or goods according to claim 1. The vehicle includes an elongated pressurized gas storage module for containing a gaseous fuel of the vehicle, characterized in that the storage module includes a single tank disposed vertically in the enclosed space of the vehicle along one side of the vehicle.

The use of a single tank makes it possible to reduce installation constraints, particularly connection constraints and the associated leakage risks. The vertical position of the tank allows the volume to be used from top to bottom in the enclosed space by limiting the footprint on the floor. By placing the storage module on the side, a passage space can be preserved from a side door in vehicles that are equipped with one. The connection of the tank to the engine is simplified as a single line is sufficient with a single connection point to the tank. With such a storage module, it is possible to equip vehicles without modifying their structure, even if they were not initially designed for this equipment.

According to one arrangement, the storage module is intended and equipped to contain dihydrogen. Adaptation to this gas results in specific arrangements on the materials used, in particular with regard to sealing, and on the equipment or such as valves and/or pressure reducers with which the tank is provided.

According to one embodiment, the tank has a cylindrical shape and is closed by end covers, the storage module including a frame supporting the tank, the frame being fastened to the vehicle. This shape allows the tank to best respond to the mechanical constraints linked to the pressure of the gas contained. The frame makes it possible on the one hand to protect the tank and on the other hand to avoid transmitting additional constraints to it for its fastening.

According to one constructive arrangement, the frame includes a fastener connecting the tank to a lower end of the tank. This fastener makes it possible to support the weight of the tank and its contents while allowing the expansion of the walls of the tank depending on the pressure of the gas.

According to one constructive arrangement, the frame includes at least one cross member fastened to two opposite side uprights of the vehicle. This makes it possible to fasten the storage module to particularly strong points of the vehicle.

According to one improvement, the frame includes a removable cover extending across the entire width of the frame and positioned at the upper part of the frame. The use of a removable cover for the frame makes it possible to reduce the height thereof during the installation phases in the vehicle. The reduction of this height makes it possible in particular to insert the storage module horizontally, then to straighten it in the enclosed space and finally to replace the removable cover in order to consolidate the frame. This optimizes the use of the space by having a tank which extends practically across the entire height available in the enclosed space.

According to one particular arrangement, a transverse partition separates the enclosed space into a cab on the one hand and a loading space on the other hand, the storage module being positioned in the loading space along the partition. This arrangement particularly concerns van-type vehicles in which the loading space is intended to contain goods while being separated by the partition from the cab where the driver is installed. This arrangement makes it possible to secure the occupants of the cab against an accidental gas leak.

In another arrangement, the frame includes a compartment containing the tank, advantageously in a substantially sealed manner, and at least one orifice for establish fluid communication between the volume inside the compartment and the outside of the vehicle. The compartment makes it possible on the one hand to protect physical access to the tank and on the other hand to contain any gas leaks in a delimited volume and to conduct these gases to the outside through the orifice. It is thus possible to place the storage module inside the enclosed space, even if the latter is intended to accommodate persons. The orifice can be provided with a simple ventilation grille or a ventilation grille with a fan which forces the circulation of air.

Typically, the compartment extends from the floor to the ceiling, where it is joined in a sealed manner. Preferably, the compartment surrounds the tank around its entire periphery to define an enclosed volume. Alternatively, the compartment surrounds the tank around the majority of its periphery and cooperates with the bodywork on the side of the vehicle to form an enclosed volume surrounding the tank.

The invention also relates to an adaptation kit for a light commercial vehicle having an enclosed space, the kit including a storage module with a single tank fastened to a frame, the frame being arranged to be fastened to the vehicle with the tank in a vertical position in the enclosed space of the vehicle along one side of the vehicle. It is thus possible to equip a light commercial vehicle that was not initially intended to be powered by a gas supply, in particular dihydrogen, with a powertrain using a gaseous fuel.

According to one embodiment, the frame includes a cover without which the storage module can move from a horizontal position to a vertical position inside the enclosed space, and with which the storage module cannot move from the horizontal position to the vertical position inside the enclosed space.

### BRIEF DESCRIPTION OF THE FIGURES

The invention will be better understood and other features and advantages will appear on reading the description which follows, the description making reference to the appended drawings among which:

FIG. 1 is a cutaway view of a light commercial vehicle according to a first embodiment of the invention;

FIG. 2 is a top view of the vehicle of FIG. 1, shown without the roof;

FIG. 3 is a perspective view of a kit intended to equip the vehicle of FIG. 1;

FIG. 4 is a view showing an intermediate position of the kit of FIG. 3 during mounting in the vehicle of FIG. 1;

FIG. 5 is a view of the detail V of FIG. 4;

FIG. 6 is a view similar to FIG. 2 for a vehicle according to a second embodiment of the invention.

### DETAILED DESCRIPTION

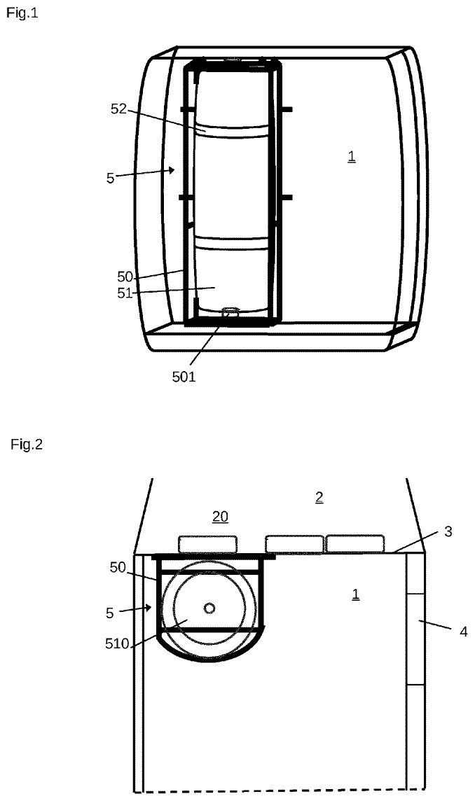

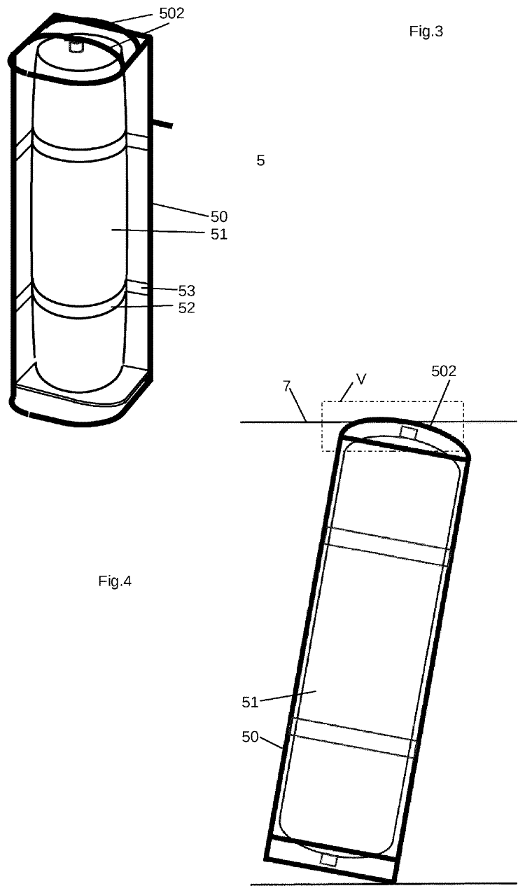

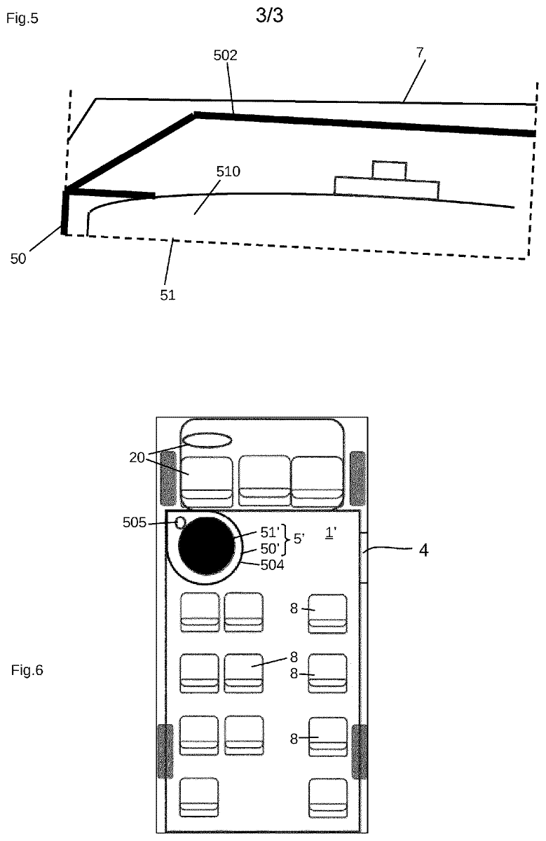

A light commercial vehicle according to a first embodiment of the invention is shown in FIGS. 1 to 5. The vehicle is of the type including a loading space 1 separated from a cab 2 by a transverse partition 3, the cab 2 housing the driving station 20 of the vehicle. This type of vehicle is conventionally called a van. For example, the cross-section of the enclosed space 1 is higher than it is wide and has a height that can typically be 1.9 m or 2.2 m. The enclosed space 1 is accessible via rear doors, not shown, located at the rear of the vehicle and by a sliding side door, of which only the opening 4 is indicated, on the side opposite the driving station 20 just behind the transverse partition 3. The partition can be a solid partition to sealingly isolate the cab 2 from the loading space 1.

The vehicle includes an elongated pressurized gas storage module 5 for containing a gaseous fuel for the vehicle, in this case dihydrogen. The engine of the vehicle is a heat engine, not shown, specially adapted to receive dihydrogen (in the gaseous state) as fuel.

The storage module 5 includes a frame 50 supporting a single tank 51 and disposed vertically in the enclosed space 1 of the vehicle along one side of the vehicle at the rear of the driving station 20. The tank 51 has a cylindrical shape and is closed by rounded end covers 510. The frame 50 is fastened to the vehicle in a manner not detailed here, but which may be by screwing, bolting or welding. The frame 50 is made up of metal bars extending vertically and/or horizontally and assembled together, in particular by welding.

The frame 50 includes a fastener 501 connecting the tank 51 to a lower end of the tank 51. The fastener 501 has the form of a plate fastened to the frame 50 by its edges and on which the tank 51 rests at the center of one of its end covers 510. The storage module 5 further includes a system of straps 52 surrounding the cylindrical part of the tank 51 in order to keep the latter resting on cradles 53 integrated into the frame 50. The frame 50 further includes a removable cover 502 which maintains the rigidity of the frame 50, but which can be removed during the phase of mounting the storage module 5 inside the vehicle.

The frame 50 may also include a cross member (not shown) which is fastened to two opposite lateral uprights (providing a structural support) of the vehicle. The cross member may extend horizontally, substantially halfway up the enclosed space 1, and along the transverse partition 3. Such a cross member makes it possible to transmit loads to the vehicle bodywork in case of a frontal impact without stressing the transverse partition 3.

The storage module 5 is provided in the form of an adaptation kit of a light commercial vehicle having an enclosed space 1, to equip either existing vehicles or new vehicles outside a production line. The kit includes the single tank 51 fastened to the frame 50, the frame 50 being intended to be fastened to the vehicle with the tank 51 in a vertical position in the enclosed space 1 of the vehicle along one side of the vehicle.

The frame 50 includes the cover 502 without which the storage module 5 can move from a horizontal position to the vertical position inside the enclosed space 1, and with which the storage module 5 cannot move from the horizontal position to the vertical position inside the enclosed space 1. FIG. 4 shows that, with the cover 502 in place, there is interference between the frame 50 and the roof 7 of the vehicle during the phase of moving from the horizontal position to the vertical position. By removing the cover 502, this interference is avoided. It is thus possible to use a maximum of available height to have the maximum height dimensions and therefore capacity for the tank 51.

In a second embodiment of the invention shown in FIG. 6, the light commercial vehicle is a vehicle for transporting persons in the enclosed space 1′ and provided with seats 8 for the passengers. Such a vehicle is commonly called a mini-bus. In this embodiment, the storage module 5′ is also positioned at the rear of the driving station 20. The frame 50′ includes a compartment 504 containing the tank 51′ and at least one orifice 505 for establishing fluid communication between the volume inside the compartment 504 and the outside of the vehicle.

The compartment 504 is made with solid walls, and any junctions are treated to be watertight, for example with flexible joints or with mastic. The compartment 504 is complete so as not to leave any communication between the volume inside the compartment and the enclosed space 1′. It can be seen that the volume around the tank 51′ is not in fluid communication with the inside of the enclosed space 1′. In addition, the vehicle is equipped with a gas sensor, adapted to the type of gas used, and which triggers an alert in case of a predetermined threshold of a gas concentration being exceeded. The sensor samples the gas preferably in the space delimited by the compartment.

The invention is not limited to the embodiments just described as examples. The contained gas could be another type of gas such as propane, natural gas or petroleum gas.

The tank 51 may be of any suitable type, in particular type I to IV, and in particular type II or III, that is to say with a metal (steel or aluminum) inner tank and a fiber composite casing. The tank is typically designed for a filling pressure of 350 to 700 bars. Typically, the tank may have a capacity of 300 liters or more, in particular of 350 liters, or even 400 liters.

1. A light commercial vehicle having an enclosed space intended to house persons or goods, the vehicle comprising an elongated pressurized gas storage module for containing a gaseous fuel for the vehicle,
wherein the storage module comprises a single tank disposed vertically within the enclosed space of the vehicle along one side of the vehicle.

2. The vehicle according to claim 1, wherein the storage module is intended and equipped to contain dihydrogen.

3. The vehicle according to claim 1, wherein the tank has a cylindrical shape and is closed by end covers, the storage module comprising a frame supporting the tank, the frame being fastened to the vehicle.

4. The vehicle according to claim 3, wherein the frame comprises a fastener connecting the tank to a lower end of the tank.

5. The vehicle according to claim 3, wherein the frame comprises a removable cover extending across the entire width of the frame and positioned at an upper part of the frame.

6. The vehicle according to claim 1, wherein a transverse partition separates the enclosed space on the one hand into a cab and on the other hand into a loading space, the storage module being positioned in the loading space along the partition.

7. The vehicle according to claim 1, wherein the frame comprises a compartment sealingly containing the tank and at least one orifice for establish fluid communication between the volume inside the compartment and the outside of the vehicle.

8. An adaptation kit for a light commercial vehicle having an enclosed space the kit comprising a storage module with a single tank fastened to a frame the frame being configured to be fastened to the vehicle with the tank in a vertical position within the enclosed space of the vehicle along one side of the vehicle, to obtain a light commercial vehicle according to claim 1.

9. The kit according to claim 8, wherein the frame comprises a removable cover extending across the entire width of the frame and positioned at an upper part of the frame, without which the storage module can be moved from a horizontal position to the vertical position within the enclosed space, and with which the storage module cannot be moved from the horizontal position to the vertical position within the enclosed space.
